(19) United States
(12) Patent Application Publication
(10) Pub. No.: US 2006/0162382 A1
(43) Pub. Date: Jul. 27, 2006

(54) Method and apparatus for producing oxide particles via flame

(76) Inventors: Kenneth Edward Hrdina, Horseheads, NY (US); Terry Lee Taft, Big Flats, NY (US); Michael Henry Wasilewski, Corning, NY (US)

Correspondence Address: CORNING INCORPORATED, SP-TI-3-1, CORNING, NY, 14831, US

(21) Appl. No.: 11/323,948

(22) Filed: Dec. 29, 2005

Related U.S. Application Data
(60) Provisional application No. 60/640,697, filed on Dec. 30, 2004.

(51) Int. Cl. C03B 19/10

(52) U.S. Cl. 65/21.1

(57) ABSTRACT

Disclosed are process and apparatus for making oxide soot particles where an atomizing burner is used as well as process for making densified silica-containing glass bodies by using soot particles having specific surface area of less than about 50 m²/g. Large glass bodies can be produced with less drying time and less binders by using such particles. The invention is particularly advantageous for the production of TiO₂-doped silica glass.

### CROSS-REFERENCE TO RELATED APPLICATIONS

The present application claims the benefit under 35 U.S.C. § 119 of U.S. Patent Provisional Patent Application Ser. No. 60/640,697, filed on Dec. 30, 2004 and entitled “METHOD AND APPARATUS FOR PRODUCING OXIDE PARTICLES VIA FLAME,” the content of which is relied upon and incorporated herein by reference in its entirety.

### FIELD OF THE INVENTION

The present invention relates to processes and apparatuses for producing doped and undoped oxide particles via flame hydrolysis. In particular, the present invention relates to processes and apparatuses for producing pure or doped silica soot particles having low specific surface area. The present invention is useful, for example, in the production of pure or doped silica soot for extrusion.

### BACKGROUND OF THE INVENTION

Clean silica or doped silica powders are currently manufactured by such companies as Degussa and Cabot with 50 m²/g or more specific surface areas by the flame hydrolysis method. Lower specific surface area powders are desirable but not readily available, especially for doped silica glasses such as titania-doped silica. Multiple applications of these powders exist, but have been limited, in many instances, due to the unavailability of lower specific surface area powders. Casting of powders and pressing of powders is often slow or accompanied by breakage due to the extremely high capillary stresses associated with high specific surface area powders.

One application is for ultra low expansion glass which has been produced for many years for extensive use in lightweight space based mirrors as well as land based mirrors. The material has also found uses in extremely sensitive measurement devices and is targeted for use in extreme ultra-violet light (“EUVL”) systems as substrates for the optics, photomasks and also light weight support. One problem typically found in this material is striae, formed during the manufacturing process. This property has not caused issues with past or current products but for proposed future uses such as photomask and optical lenses, striae can not be tolerated. An alternate process currently under development is soot casting. To date, striae-free samples have been produced and meet all the strict specifications required for ultra-low-expansion glass. A second process under development is the extrusion of glass webbing for light-weight space based mirrors, designed to replace the current method which involves machining large amounts of glass from bulk glass to obtain the light weight structure. Both casting and extrusion methods will require large amounts of high purity soot and lower specific surface areas have been found to be advantageous. Titania doped soot will be used for EUVL applications while pure silica soot could be used by the mirrors or have other applications. A smaller specific surface area (larger particle size) is needed for extrusions in order to prevent cracking during the drying process of the extruded parts.

In normal production of pure or doped silica soot for either collection (for use in the casting and extrusion processes) or consolidation directly to glass in a production furnace, both the silicon and titanium precursors need to be thoroughly mixed in the proper proportion and introduced as a fume into the burner flame via the fume tube. Precursors used in the past are silicon and titanium metal halides and although presented potential health hazards were very friendly to fume delivery processes such as vaporization or by gas saturation by bubbling a gas such as oxygen or nitrogen up through the liquid precursor and then to the burner fume tube. Due to environmental concerns these precursors were deemed unsuitable because of the chlorine emissions into the environment. As a result organo-metallics such as Octamethylcycloteteasiloxane (OMCTS) have been used as the source for the silica and titanium IV isopropoxide (“Ti-Pox,”) as the source for the titanium. There are few if any process issues with the OMCTS precursor. But the opposite is true with the Ti-Pox precursor, which is very hygroscopic. Great care must be taken to ensure no water is present either in the OMCTS or delivery gasses. The same two processes (vaporization and gas saturation) are still currently used to deliver the fume to the burner. For the vaporization process, the OMCTS and Ti-Pox liquids are premixed before delivering to the vaporizer. In the gas saturation process nitrogen is bubbled through separate tanks of each precursor, then mixing both saturated streams and then delivering to the burner. Problems have been inherent in both systems in that a reaction seems to occur in the mixed fume streams of both processes, forming a solid precipitate which results in inclusions in the soot and consequently inclusions in the formed glass. This precipitate also builds up on the inside of the vaporizer and fume delivery system, resulting in complete plugging and shut down of the process. The system must then be disassembled and thoroughly cleaned before soot production can continue.

Therefore, there remains a genuine need of a process and apparatus adapted for the production of doped or pure silica soot particles. The present invention satisfies this need. In addition, more efficient processes for making densified high-purity silica-containing glass materials from soot particles are also desired.

### SUMMARY OF THE INVENTION

Thus, according to a first aspect of the present invention, it is provided an apparatus for producing inorganic oxide soot particles, particularly doped and pure silica soot particles, by using flame hydrolysis of organosilicon and/or organometallic soot precursor compounds, comprising:

at least one storage vessel where soot precursor compounds, at least partly in liquid state, is introduced and stored;

an atomizing burner capable of atomizing the liquid precursor compounds where the precursor compounds are flame hydrolyzed to form the oxide soot particles; and

a liquid precursor compound delivering system delivering the liquid precursor compounds from the storage vessel to the burner.

In one embodiment of the apparatus of the present invention, it comprises only one storage vessel where the precursor compounds are mixed and stored.

In another embodiment of the apparatus of the present invention, it comprises multiple storage vessels where the precursor compounds are stored separately.

In another embodiment of the apparatus of the present invention, the precursor compound delivery system comprises meters for measuring flow rates of the precursor compounds and devices for adjusting the flow rates of the precursor compounds.

In one embodiment of the apparatus of the present invention, the at least one soot precursor compound are mixed immediately before entering the atomizing burner.

In one embodiment of the apparatus of the present invention, the apparatus is capable of a precursor flow rate of at least 8 grams/minute.

In one embodiment of the apparatus of the present invention, the apparatus is capable of a precursor flow rate of at least 15 grams/minute.

In one embodiment of the apparatus of the present invention, it is capable of generating a flame having a length of at least 8 inches.

In another embodiment of the apparatus of the present invention, it is capable of generating a flame having a length of at least 10 inches.

In one embodiment of the apparatus of the present invention, the apparatus further comprises: a soot particle cooling system capable of providing gas flow at a temperature below about 200° C., preferably below about 150° C. for cooling the soot particles.

According to a second aspect of the present invention, it is provided use of the apparatus of the present invention, described above and below, in the production of titanium-doped silica soot particles using organo-silicon and organotitanium precursor compounds.

A third aspect of the present invention is a process of making oxide soot particles, comprising the following steps:

(I) providing at least one soot precursor compound at least partly in liquid state;

(II) providing an atomizing burner capable of atomizing the at least one liquid precursor compound;

(III) delivering the at least one liquid soot precursor compound to the atomizing burner;

(IV) forming soot particles at the location of the atomizing burner via flame hydrolysis of the at least one precursor compound; and

(V) cooling the soot particles by a gas flow having a temperature lower than 200° C.

In certain embodiments of the process of the present invention, the average specific area of the soot particles produced is less than about 50 m²/g. In certain embodiments, it is preferred that the average specific area of the soot particles is less than about 20 m²/g. In certain embodiments, the flow rate in step (V) has a temperature lower than about 150° C.

In certain embodiments of the process of the present invention, the at least one soot particle precursor compounds are selected from organosilicon compounds, organotitanium compounds, silicon halides and titanium halides. In certain embodiments, the at least one soot particle precursor compounds consist of OMCTS and Ti-POX. The OMCTS and Ti-POX may be stored in separate vessels before being delivered to the burner. The OMCTS and Ti-POX may be mixed immediately prior to entering the atomizing burner.

A fourth aspect of the present invention relates to a process for making silica-containing glass bodies, comprising the following steps:
(i) providing a plurality of silica-containing glass soot particles with an average specific area of lower than about 50 m²/g;
(ii) forming the particles into a green body having a bulk shape;
(iii) removing solvents and organics contained in the green body, if any;
(iv) optionally purifying the green body; and
(v) consolidating the green body into densified glass body.

In certain embodiments of this process of the present invention, in step (i), the glass soot particles comprise TiO₂ 0-10% by weight. In certain other embodiments of this process of the present invention, in step (i), the soot particles have a specific area of less than about 20 m²/g.

In certain other embodiments of this process of the present invention, in step (ii), the particles are formed into green body via extrusion, injection molding, casting, dry pressing, isostatic pressing or free-form fabrication.

In certain other embodiments of this process of the present invention, in step (i), the soot particles are provided by a process comprising the following steps:

(I) providing at least one soot precursor compound at least partly in liquid state;

(II) providing an atomizing burner capable of atomizing the liquid precursor compounds;

(III) delivering the at least one liquid soot precursor compound to the atomizing burner;

(IV) forming soot particles at the location of the atomizing burner via flame hydrolysis of the at least one precursor compound; and

(V) cooling the soot particles by a gas flow having a temperature lower than 200° C., preferably lower than about 150° C.

The present invention has the advantage of producing large particles having an average specific area less than about 50 m²/g adapted for use in extrusion and casting. The present invention has the advantage of being capable of producing particles without the problem of formation of particles in the precursor delivery pipeline. The present invention also has the advantages of producing densified silica-containing glass bodies with large size, less drying time, higher yield and lower level of impurities.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings,

FIG. 1 is a schematic illustration of an embodiment of the apparatus setup of the present invention for the production of doped or pure silica soot particles, where liquid precursor compounds are mixed and placed in a single vessel before being delivered to the liquid feed burner.

FIG. 2 is a schematic illustration of another embodiment of the apparatus setup of the present invention for the production of doped or pure silica soot particles, where liquid precursor compounds are placed in separate vessels and delivered to the liquid feed burner.

### DETAILED DESCRIPTION OF THE INVENTION

Specific surface area of a plurality of particles is the combined area of the particles per unit weight, usually expressed in terms of m²/gram. Specific area or specific surface area as used herein in the present application means average specific surface area of the particles. Typically, the finer the particles, the higher the specific area, and vice versa. The present inventors have found that specific surface area of the soot can be controlled by several methods. The size and shape of the flame is one such method that impacts specific surface area. As the precursor enters the flame and burns, tiny particles of glass are formed. As the particles continue to pass through the flame the particles coalesce and grow. Longer residence times in the flame, higher concentrations of oxide species in the flame and also hotter flames are three parameters found to lead to larger particle sizes. To generate soot with a large specific surface area, three things can be done. (1) Make the flame short and ragged which reduces the residence time of the soot particles in the flame. (2) Make the flame colder, such as by using precursor species with less enthalpies of reactions such as halides. Or (3) dilute the concentration (grams oxide/ml volume) of oxides in the gas stream. To produce smaller specific surface area soot particles, the following strategy and technique may be taken: (1) maintain the soot particles in the flame as long as possible to allow for maximum growth desirably in a long, collimated flame; (2) use precursor compounds which react to create hot reacting species such as organic precursors (TPT and OMCTS as examples); or (3) use highly concentrated precursor compounds. This current invention identifies these three conditions as means of obtaining low specific surface area powders.

The present invention identifies processes and apparatuses for making low specific surface area silica or doped silica powder by a flame hydrolysis method with specific surface areas of 50 m²/g and much less.

Generally a soot producing burner using organometallics as a precursor and using a fume type delivery system requires a minimal amount (2 to 5 slpm) of inert carrier gas (generally nitrogen) to transport the precursor fume to the burner. However, an atomizing system generally requires a greater amount of carrier gas in order to achieve adequate atomization resulting in a short, turbulent flame. Also for soot production purposes, a burner capable of producing a high rate of soot would be advantageous, which would require a high precursor flow rate (≧15 grams/minute) and still maintain a long collimated flame.

A liquid feed burner has been developed for the present invention which eliminates the need for either a vaporizer or gas saturation system, eliminating the issues with the solid precipitation forming in the delivery system for the organo-metallic precursors. This simplifies the process of soot generation. If mixed oxides are desired, the invention identifies the mixing of the liquid precursors in a single delivery tank (if two components are compatible) as a means of controlling stoichiometry. Weight is a highly precise method of controlling stoichiometry. The mixed liquid is then fed to and delivered through an atomizing burner at room temperature, which adequately atomizes the liquid for burning. An atomizing system was developed for the production of high purity silica by the direct-to-glass method and described in U.S. Pat. No. 6,260,385 B1, entitled “Method and burner for forming silica-containing soot” to Daniel R. Sempolinski et al., the content of which is relied upon and incorporated herein by reference in its entirety. The original design in this patent was for the direct consolidation process for producing glass, requiring a burner with high heat output and a maximum precursor output of <8 grams/min. The maximum level used in this patent was to prevent the formation of seeds in the consolidated glass which typically occurred at high flow rates. In a soot production process, it is advantageous to limit extraneous heat output as much as possible and generate as much soot as possible. Extra heat must be diluted with a filtered air stream (usually at room temperature) to cool the flowing combusted materials. This cooling is done in order to prevent melting of the collecting filter (usually Teflon or Gortex etc.) cartridges. Targeted gas stream temperatures are usually 130° C. or less. For ordinary glass production, high levels of methane, H₂ or natural gas can be used because heat is needed to form glass. However, for powder generation without glass boule formation, only small levels of fuel must be used. The purpose of using fuel is to maintain combustion of the organo-metallic precursor. To generate a flame hot enough for the production of low specific surface area soot, the precursor flow rate was found to be >8 grams/minute and preferably above 15 grams/minute and not compromise the flame shape and length. Soot particles thus generated are glassy in nature and mixed at the atomic level. Means other than flame hydrolysis may end up with individual titania particles and silica particles as an example. This process, however, generates a titania doped silica glass particles (the silica and titania mixed and present in the particles).

This burner system eliminates the problems of fume line build-up and plugging due to precursor reactions in a vaporizer or bubbler type system, eliminating downtime and greatly increasing soot production. The elimination of need of a heated and controlled vaporizer simplifies the system and reduces capital costs. The burner is capable of generating a long (10″ to 12″) collimated flame required for production of low specific surface area soot needed for extrusion processes. The burner flows can also be adjusted to produce a shorter flame when a smaller particle size is required for processes such as soot casting. The burner also operates (and is actually required for the long flame) with a high ≧15 g/min precursor flow rate with a minimum (1 slpm) for the fuel/oxygen flame, significantly reducing heat output which is beneficial for the soot collection equipment. By using separate delivery pumps with the capability of metering the liquid precursors within the required tolerances, premixing the precursor is not necessary, but can be delivered from separate tanks and mixed in the delivery line prior to delivery to the burner. Use of organic precursors allow generation of heat in the areas where the particles form and is needed and an efficient means of supply heat for particle coalescence. Halide containing precursors can be avoided and thus result in less pollution abatement systems required.

The burner described in this invention is designed to produce soot in a large range of particle sizes up to 50 m²/g. For example, it can be used to produce particles having an average specific area of about 20 m²/gram (which is the size needed for successful soot extrusion), or lower. The burner has a small premix area because the area is only needed to maintain combustion of the precursor materials. To produce the long collimated flame necessary for the smaller specific surface area soot and to increase soot production rate, a high precursor flow rate is required, and to accomplish this a larger than normal inner shield annulus is desirable.

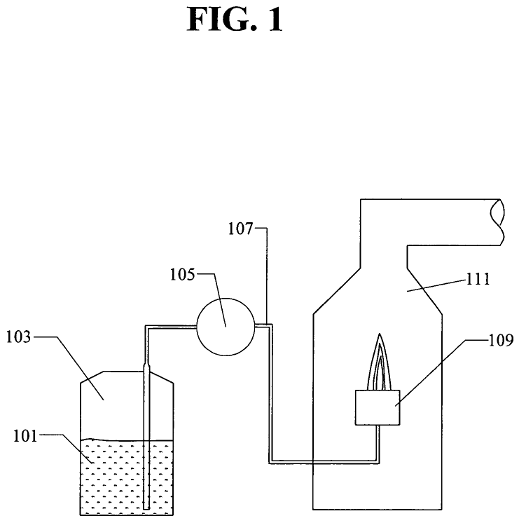

FIG. 1 schematically illustrates the apparatus set-up of one embodiment of the apparatus of the present invention. In this embodiment, the liquid precursor compound, such as OMCTS or mixtures of liquid precursor compounds (such as OMCTS and Ti-POX), 101, is stored in a single tank 103, delivered via pump 105 through the liquid precursor delivery line 107 to the atomizing burner 109, where it is atomized and converted into soot particles which are collected in the soot collector 111.

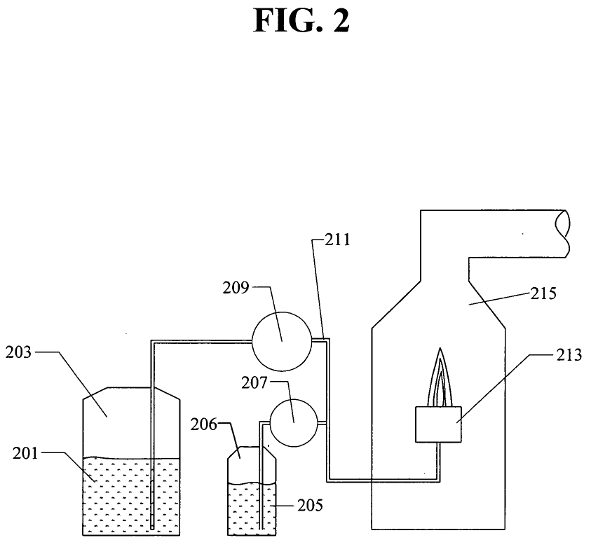

FIG. 2 schematically illustrates the apparatus set-up of another embodiment of the apparatus of the present invention. In this embodiment, two liquid precursor compounds (such as OMCTS and Ti-POX) are stored in separate tanks. The silicon precursor compound 201, such as OMCTS, is stored in tank 203 and delivered by pump 209 to liquid feed line 211. The dopant precursor compound 205, such as Ti-POX, is stored in tank 206 and delivered by pump 207 to liquid feed line 211. Thus the silicon precursor liquid and the dopant precursor liquid are mixed in the liquid feed line prior to reaching the burner 213. At the atomizing burner 213, the precursor compounds are converted to soot particles via flame hydrolysis, which are collected by the soot collector 215.

The third aspect of the present invention relates to a process for making densified silica-containing glass bodies starting from silica-containing glass soot particles having a specific area of less than about 50 m²/g comprising the following steps:
(i) providing a plurality of silica-containing glass soot particles with an average specific area of lower than about 50 m²/g;
(ii) forming the particles into a green body having a bulk shape;
(iii) removing solvents and organics contained in the green body, if any;
(iv) optionally purifying the green body; and
(v) consolidating the green body into densified glass body.

The present inventors have found that, if glass particles having a specific area of higher than about 50 m²/g are used, large soot green bodies are more difficult to obtain due to the high capillary stress between the soot particles. Typically, prolonged drying time is required in order to avoid cracking during drying if larger specific-area particles are used; more organic binder has to be used during forming, thus a higher probability of introducing more impurities into the green body and the final densified glass. The present inventors, by using particles with specific area lower than about 50 m²/g, solve the theses problems: the green body drying time is reduced; less organic binder is used, rendering it possible to produce large glass bodies with high purity.

In certain embodiments, the soot particles for the production of densified silica-containing glass bodies according to the process of the present invention is advantageously provided in step (i) by using the process or apparatus of the present invention as described supra. The glass soot particles may be doped or undoped.

In the forming step (ii), the soot particles can be formed into a green body via extrusion, injection molding, soot casting, free-form fabricating, dry pressing, isostatic pressing, and the like. In certain embodiments, it is preferred that extrusion, injection molding or casting is used.

In the forming step (ii), the soot particles may be dispersed in solvents such as water. Dispersing agents, such as ammonia, may be used. Organic binders may be mixed with the particles for successful forming. The process of the present invention enables the use of reduced amount of binders than processes using particles with specific area higher than about 50 m²/g.

Prior to consolidation of the green body into densified glass, the green body is allowed to dry such that the solvents, if any, contained in the green body is removed. If the green body contains other organics, such as organic binders, they are typically removed prior to consolidation, via, for example, oxidation and/or evaporation.

Prior to consolidation, the green body may be subjected to purification where necessary. Purification may be heat treatment in an atmosphere containing halogen or halogen-containing compounds. Prior to consolidation thereof, the green body may be doped with various dopants as well.

In the final step of the process of the present invention, the green body is sintered or consolidated at a high temperature to form into a consolidated glass.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

What is claimed is:

1. An apparatus for producing inorganic oxide soot particles, such as doped and pure silica soot particles by using flame hydrolysis of organosilicon and/or organometallic soot precursor compounds, comprising:
at least one storage vessel where soot precursor compounds, at least partly in liquid state, is introduced and stored;
an atomizing burner capable of atomizing the liquid precursor compounds where the precursor compounds are flame hydrolyzed to form the oxide soot particles; and
a liquid precursor compound delivering system delivering the liquid precursor compounds from the storage vessel to the burner.

2. An apparatus according to claim 1 comprising only one storage vessel where the precursor compounds are mixed and stored.

3. An apparatus according to claim 1 comprising multiple storage vessels where the precursor compounds are stored separately.

4. An apparatus according to claim 1, wherein the precursor compound delivery system comprises meters for measuring flow rate of the precursor compounds and devices for adjusting the flow rate of the precursor compounds.

5. An apparatus according to claim 1, wherein the at east one soot precursor compounds are mixed immediately before entering the atomizing burner.

6. An apparatus according to claim 1 capable of a precursor flow rate of at least 8 grams/minute.

7. An apparatus according to claim 1 capable of a precursor flow rate of at least 15 grams/minute.

8. An apparatus according to claim 1 capable of generating a flame having a length of at least 8 inches.

9. An apparatus according to claim 1 capable of generating a flame having a length of at least 10 inches.

10. An apparatus according to claim 1, further comprising:
a soot particle cooling system capable of providing gas flow at a temperature below about 200° C.

11. Use of the apparatus of clam 1 in the production of titanium-doped silica soot particles using organo-silicon and organotitanium precursor compounds.

12. Use of claim 11, wherein the organo-silicon compound is OMCTS, and the organotitanium compound is Ti-POX.

13. A process for making oxide soot particles, comprising the following steps:
(I) providing at least one soot precursor compound at least partly in liquid state;
(II) providing an atomizing burner capable of atomizing the liquid precursor compounds;
(III) delivering the at least one liquid soot precursor compounds to the atomizing burner;
(IV) forming soot particles at the location of the atomizing burner via flame hydrolysis of the at least one precursor compound; and
(V) cooling the soot particles by a gas flow having a temperature lower than 200° C., preferably lower than about 150° C.

14. A process for making oxide particles according to claim 13, wherein the particles produced have particle specific area lower than 50 m²/g.

15. A process for making oxide particles according to claim 13, wherein the at least one soot particle precursor compound is selected from organosilicon compounds, organotitanium compounds, silicon halides and titanium halides.

16. A process for making oxide particles according to claim 15, wherein the at least one soot particle precursor compounds consists of OMCTS and Ti-POX.

17. A process for making oxide particles according to claim 16, wherein the OMCTS and Ti-POX are stored in separate vessels before being delivered to the burner.

18. A process for making oxide particles according to claim 17, wherein the OMCTS and Ti-POX are mixed immediately prior to entering the atomizing burner.

19. A process for making silica-containing glass bodies, comprising the following steps:
(i) providing a plurality of silica-containing glass soot particles with an average specific area of lower than about 50 m²/g;
(vi) forming the particles into a green body having a bulk shape;
(vii) removing solvents and organics contained in the green body, if any;
(viii) optionally purifying and/or doping the green body; and
(ix) consolidating the green body into densified glass body.

20. A process according to claim 19, wherein in step (i), the glass soot particles comprise TiO₂ 0-10% by weight.

21. A process according to claim 19, wherein in step (i), the soot particles are provided by the process of claim 13.
